(19) United States
(12) Patent Application Publication
(10) Pub. No.: US 2022/0366806 A1
(43) Pub. Date: Nov. 17, 2022

(54) TECHNOLOGY FOR EXAM QUESTIONS

(71) Applicant: International Business Machines Corporation, Armonk, NY (US)

(72) Inventors: VIKAS KUMAR MANORIA, Bengaluru (IN); Prasad Velagapudi, Visakhapatnam (IN); Sivapatham Muthaiah, Bangalore (IN); Priya Vasudevan, Pune (IN)

(21) Appl. No.: 17/318,818

(22) Filed: May 12, 2021

(51) Int. Cl. G09B 7/02; G09B 5/02; G06N 5/02

(52) U.S. Cl. CPC G09B 7/02; G09B 5/02; G06N 5/02

(57) ABSTRACT

Course content is received by a computer system, which performs an exam question generating procedure for the content. This includes receiving defining parameters for generating a potential exam question about the course, generating candidate questions for the potential exam question responsive to the course content and the received parameters, presenting the candidate questions, receiving, a selection of one of the candidate questions, generating an answer for the selected question responsive to the course content, the received parameters and the selected question; and generating and presenting an evaluation for the generated answer responsive to the generated answer, the course content, the received parameters and the selected question.

### BACKGROUND

Students take courses in many contexts, wherein they are provided with lessons (also referred to as “modules”) for learning course objectives and are provided with exam questions for evaluating achievement of the objectives. For convenience, efficiency, and technology limitations, questions are often limited to multiple choice, true/false, matching, mapping, fill in the blanks, and short answer.

### SUMMARY

In an embodiment of the present invention, a computer system implemented method comprises receiving, by the computer system, course content for a course of study and performing a certain exam question generating procedure for the course content.

In other aspects, performing the certain exam question generating procedure includes: receiving, by the computer system, defining parameters for generating a potential exam question about the course content; generating automatically, by a first program module executing on the computer system, candidate questions for the potential exam question responsive to the course content and the received defining parameters; presenting the candidate questions to the user by the computer system; and receiving, by the computer system, a selection of one of the candidate questions.

Additionally, performing the certain exam question generating procedure further includes: generating automatically, by a second program module executing on the computer system, an answer for the selected question responsive to the course content, the received defining parameters and the selected question; generating automatically, by the first program module, an evaluation for the generated answer responsive to the generated answer, the course content, the received defining parameters and the selected question; and presenting the answer evaluation to a user by the computer system.

In other embodiments of the invention, other forms are provided, including a system and a computer program product.

### BRIEF DESCRIPTION OF THE DRAWINGS

Features and advantages of the present invention will be more readily understood with reference to the attached figures and following description, wherein:

FIG. 1 illustrates a networked computer environment, according to embodiments of the present invention;

FIG. 2 is a block diagram of a computer system such as those shown in FIG. 1, according to embodiments of the present invention;

FIG. 3 depicts a cloud computing environment according to an embodiment of the present invention;

FIG. 4 depicts abstraction model layers according to an embodiment of the present invention;

FIG. 5 depicts a configuration of data and processing structures, according to embodiments of the present invention; and

FIG. 6 is a flow chart depicting aspects of processing, according to embodiments of the present invention.

### DETAILED DESCRIPTION

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments of the present invention involve a recognition that evaluating achievement of course objectives might be improved by providing questions requiring essay answers, which do not provide the student with rigid structures for required answers and which require answers to be longer than a five or ten word maximum such as may be required by short answer questions. (Herein, such questions may also be referred to as “essay questions,” “long answer” questions or simply “long” questions.) Such questions are generally more challenging to prepare and evaluate than questions that provide the student with rigid structures for required answers. Embodiments of the present invention provide ways for automatically generating such exam questions and evaluating those questions.

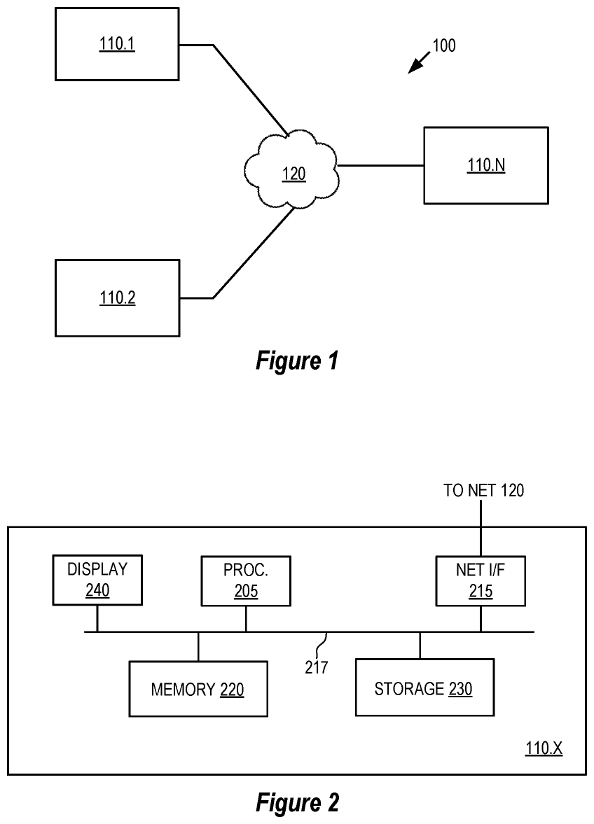

FIG. 1 illustrates an example computing environment 100 suitable for embodiments of the present invention. As shown, computing environment 100 includes computer systems 110.1, 110.2 through 110.N connects via network 120, which may be a public or private network. Systems 110.1, 110.2, etc. include modules, which may be program or hardware modules, configured to perform tasks for their own respective systems or for other systems or both, including tasks as described for elements of FIGS. 2 through 8 herein.

FIG. 2 illustrates details of a computer system 110.X suitable as computer systems 110.1, 110.2, etc. according to embodiments of the present invention, wherein system 110.X includes at least one central processing unit (CPU) 205, network interface 215, interconnect (i.e., bus) 217, memory 220, storage device 230 and display 240. CPU 205 may retrieve and execute programming instructions stored in memory 220 for applications. Similarly, CPU 205 may retrieve and store application data residing in memory 220. Interconnect 217 may facilitate transmission, such as of programming instructions and application data, among CPU 205, storage 230, network interface 215, and memory 220. CPU 205 is representative of a single CPU, multiple CPUs, a single CPU having multiple processing cores, and the like. Additionally, memory 220 is representative of a random-access memory, which includes data and program modules for run-time execution. It should be understood that system 110.X may be implemented by other hardware and that one or more modules thereof may be firmware.

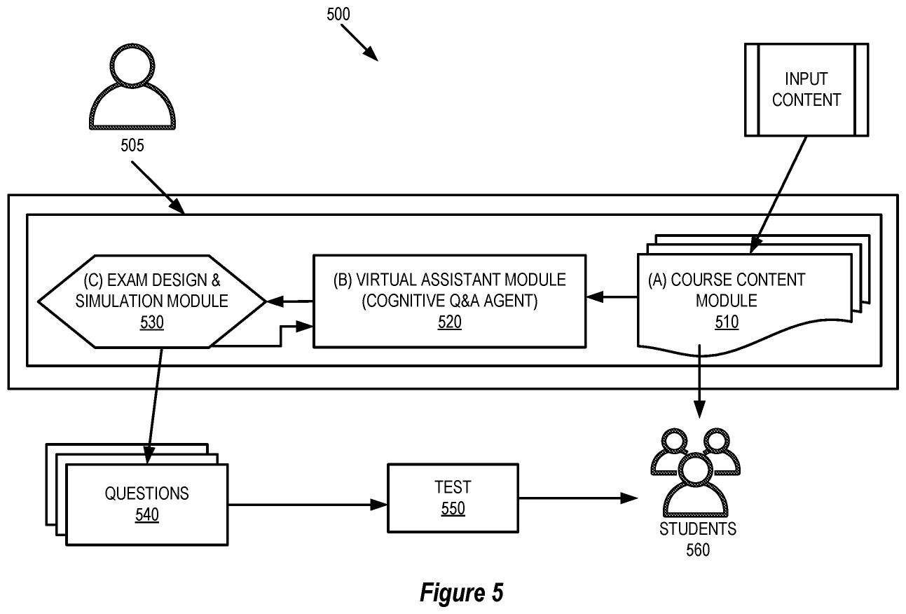

Referring to FIG. 5, course content 510 is shown for a computer implemented system 500, according to an embodiment of the present invention, where course content 510 may be in various forms, including text, audio, video, etc., and includes course objectives, a summary, and detailed outlines, which may be organized in hierarchical segments such as, for example, Course->Modules->Chapters->Topics->Subtopics. Computer program modules are provided as shown, including a Virtual Assistant Module (VAM 520) 520 and an Exam Design & Simulation Module (EDSM) 530. Both VAM 520 and EDSM 530 access overall course content 510 in computer readable memory, i.e., a course content module (“CCM) 510.

Herein below is a portion of content 510 for a course, according to an embodiment of the present invention. Specifically, the following are topics and subtopics under a “Blockchain technology” CCM 510 chapter, for example:
a) Blockchain Basics
   i. What is Blockchain?
   ii. What Blockchain is NOT!
   iii. Blockchain versions
   iv. Blockchain Variants
   v. Blockchain High level Architecture
b) Blockchain for Managers
   i. Why do we need Blockchain?
   ii. Core features overview
   iii. How Blockchain Transaction Works?
   iv. Blockchain Use Cases
   v. Important Real-Life Use Cases of Blockchain
c) Blockchain for Architects
   i. Bitcoin cryptocurrency: Most Popular Application of Blockchain
   ii. Blockchain vs. Shared Database
   iii. Myths about Blockchain
   iv. Limitations of Blockchain technology
   v. Future Roadmap

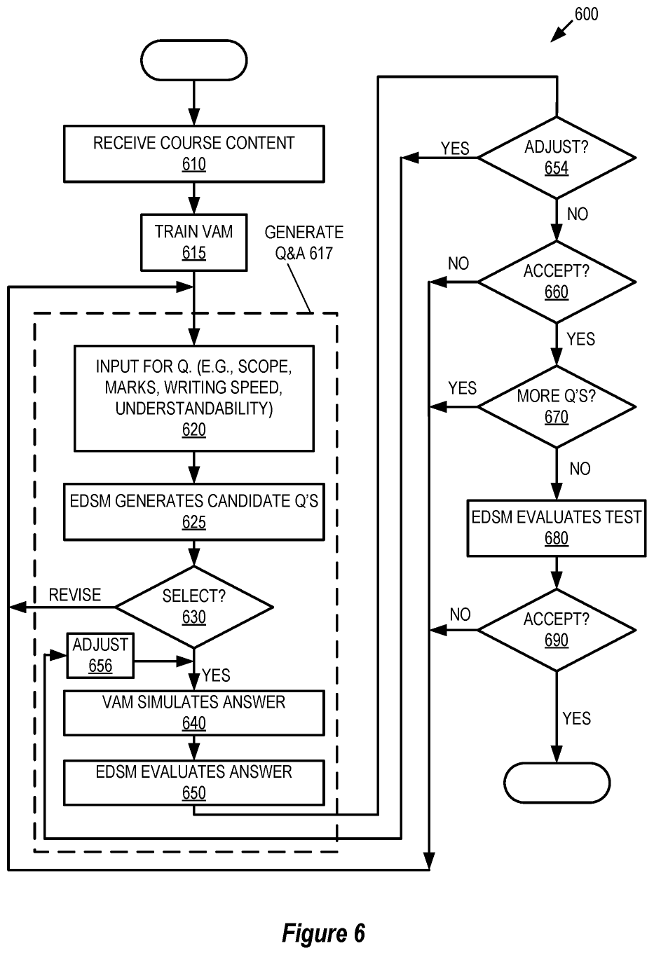

The following and FIG. 6 provide a general description of a process 600 for automatically preparing and evaluating exam questions for the course and for automatically evaluating an overall set of the exam questions, according to an embodiment of the present invention. (Since process 600 may be implemented on system 500, the description herein is best understood with reference also to FIG. 5.) VAM 520 provided in system 500 includes a Cognitive Q&A application that is known in the art, which user trains with the CCM 5510 that will be presented to students 560 of the course for them to study in preparation for an exam 550. That is, CCM 510 is provided to system 500 at 610 and then, at 615, VAM 520 is trained on the text of CCM 510, where CCM 510 may include course objectives, summary, topic/subtopic outlines, and other content, including text transcribed from any video and audio of content therein. Once VAM 520 is trained on CCM 510, VAM 520 is capable of generating 650 answers to questions 540 about content 510 by using advanced text analytics features included in VAM 520, as known in the art.

Generating 650 answers to questions 540 is part of the certain question and answer generating procedure 617 illustrated in FIG. 6 and described herein below, according to an embodiment of the present invention. In procedure 617, EDSM 530 automatically generates 625 a set of candidate exam questions 540 responsive to defining parameters received 620, as described herein below. In response to candidate questions 540, system 500 receives a selection 630 of one of the questions. Upon receiving the selection 630, system 500 directs the selected question 540 to trained VAM 520 for processing 640, as shown in FIG. 6. System may, also at 630, receive edits or even a completely replaced question 540 before VAM 520 begins processing 640 question 540.) That is, in response to the selected one of the suggested questions 540 generated by EDSM 530, and in response to at least one of the defining parameters, VAM 520 uses its text analytics features to extract information including entities, relationships, keywords, and semantic rules. Based on this extracted information and on at least one of the defining parameters, VAM 520 analyses the provided course content 510, matches parts of it with defined scope received at 620, and automatically generates 640 an answer for the selected question 540, whereupon EDSM 530 generates and presents 650 an evaluation of the answer, as described herein below.

In response to the answer and its evaluation, user 505 may then accept or modify 660 the selected question 540, as desired. For example, user 505 may wish to further limit or expand the scope of question 540, which user 505 may do such as by revising defining parameters at 620, whereupon EDSM 530 automatically generates 625 a revised question 540 and VAM 520, in turn, automatically generates a revised answer in response to the revised question 540.

The following provides additional details according to embodiments of the present invention. In one aspect, for automated generation 625 of each long-answer exam question 540 and corresponding answer, system 500 receives 620 defining parameters, including:
Expected answer writing speed of the average student in terms of words per minute;
Maximum possible credit grantable to student exam takers for answering question 540 correctly and completely (also referred to herein as “marks” or “score”);
Course content scope, i.e., portion of module, chapter, etc. encompassed by question 540 and the corresponding answer;
Desired understandability level of question 540 from target student point of view; and
Specified exam duration.

The desired understandability level indicates a degree of simplicity and clarity aligned with the user's expectations for the student population. EDSM 530 measures, i.e., rates, questions 540 against this level, where the simplicity and clarity will be lower for a lower rating and higher for a higher rating. User 505 can set, i.e., input 620, this parameter for the entirety of all exam questions 540 or for each individual question 540.

Regarding the answer writing speed, if the exam questions 540 are targeted to less advanced students, then 15-20 words/minute may be appropriate, for example, but if the exam questions 540 are for post graduate students, then 50-60 words/minute may be more appropriate. System 500 uses this answer writing speed parameter to determine a total time to allocate for students to answer a question 540. A single value of the answer writing speed parameter may apply for answers to all questions 540 or respective values of the answer writing speed parameter may apply for answers to respective questions 540 based on the varying complexities of required answers. For example, a question 540 may be more complex if its answer requires the student to draw a diagram or solve a mathematical equation.

Regarding the scope, at 620 system 500 may receive topic b) from the above Blockchain example as a parameter defining the scope of question 540 and its corresponding answer. Regarding the maximum possible score, system 500 may receive at 620 a maximum possible score of 10 for answering question 540 correctly and completely. In response EDSM 530 automatically generates 625 a set of candidate questions 540, and user 505 selects 630, for example, one that asks, “How can blockchain technology help a banking organization?” For this question 540, and the indicated writing speed, possible score and scope, VAM 520 automatically generates 640 an answer and EDSM 530 automatically generates and presents 650 an evaluation of the answer. This includes EDSM 530 determining and presenting the topics and subtopics covered by the generated answer, comparing those to the topics and subtopics defined in the scope input from user 505, and highlighting the presented topics and subtopics covered by the generated answer to indicate which ones in the answer are in scope, i.e., correspond to topics and subtopics defined in the scope, and which ones are out of scope. For example, in scope highlighting may be green, while out of scope highlighting may be red.

If user 505 decides VAM 520-generated answer is adequate, then he/she can indicate at 660 it is final, which also indicates that the last inputs for question 540 and its answer are final. If user 505 decides VAM-generated answer is not adequate, then user 505 can select at 660 to go back to revise defined parameters at 620 so that EDSM 530 automatically generates 625 a revised version of the selected question 540. (Alternatively, user 505 may manually edit the selected question 540). Once user 505 has accepted the revised question at 630, VAM 520 will automatically generate 640 a new answer in response.

In an example instance, the defining parameter for scope is the following portion of the above outline:
a) Blockchain for Architects
   i. Bitcoin cryptocurrency: Most Popular Application of Blockchain Blockchain vs. Shared Database
   iii. Myths about Blockchain
   iv. Limitations of Blockchain technology
   v. Future Roadmap
      These five headings for this defined scope provide a data set used by EDSM 530 to generate a set of candidate questions 540 that user 505 may select among. Specifically, in this example, for the first question 540 of the set, EDSM 530 randomly selects a heading from the five headings of the defined scope and generates a first question 540 in response to the selected heading, where EDSM 530 generates question 540 in a way that is known in the prior art. However, if EDSM 530 determines 625 the selected heading is insufficient, then EDSM 530 instead randomly selects an additional heading from the dataset. If EDSM 530 determines the selected headings are still insufficient for generating suitable questions, EDSM 530 repeats random selections of headings within the designated set until the selected headings are sufficient. However, if EDSM 530 determines all the headings of the defined scope are insufficient, then EDSM 530 selects, in random order, three paragraphs of the CCM content 510 under the selected subtopics, finds key phrases and entities from each paragraph in a way that is known in the art, and generates question 540. In one example instance, EDSM 530 generates the following question 540 “Blockchain is said to be able to do what the internet does to the computing world today for the BF SI industry. Share your perspective on that with the help of supporting facts.”

Further, responsive to the Understandability Rating (UR) of a question 540, EDSM 530 calculates a complexity score for each potential question 540 at 625 in a way that is known in the art. If the UR of a question 540 defined at 620 exceeds a threshold value for complexity, then at 625 EDSM 530 automatically rephrases question 540 to simplify it without changing its meaning in a way that is known in the art. EDSM 530 then recalculates the UR for the new version of question 540 at 625 and, if necessary, repeats until the UR does not exceed the defined level of complexity. For example, EDSM 530 may simplify question 540 it generated 625 in the above example instance to read “For the BFSI industry, Blockchain is said to be able to do what the internet is doing to the technological world today. Offer your viewpoint with the assistance of supporting realities.”

Once EDSM 530 has generated one candidate question 540 at 625 from the one or more headings (or headings and paragraphs) randomly selected as described above, EDSM 530 automatically generates 625 additional candidate questions 540 by repeating this random selection process.

After generating a candidate question 540 that is indicated at 630 as being least initially suitable, EDSM 530 sends it to VAM 520 to automatically generate 640 an answer in response based on defining parameters, such as described herein above. More specifically, EDSM 530 may, in connection with automatically generating 625 a question 540, calculate an expected number of words (ENW) for its answer as (number of words/minute of defined answer writing speed×(number of minutes defined for the exam)×(specified marks for this question/100). Based on the scope defining parameter received at 620 for question 540, VAM 520 automatically generates 640 an answer and passes it back to EDSM 530, whereupon EDSM 530 determines at 650 the actual number of words in the generated answer and compares it with the ENW. If the result is close to ENW by +/−10%, system 500 processes question 540 further as described herein below. Otherwise, at 650 EDSM 530 presents a notice about the undesirable length and the following actions that can be selected:
Select at 654 to adjust for the currently selected question or not, where adjusting 656 may include adjusting (and then repeating answer generation 640, etc.) as follows:
   adjust the allocated marks based on the actual answer length;
   adjust question 540, which may include providing an answer template as described herein below;
   adjust by joining questions 540 for which the answers have a combined length that more closely matches the ENW; and
   adjust by accepting a different candidate question 540 that is within the specified length and scope;
Selecting at 654 to not adjust presents another action to select, i.e., selecting at 660 to accept the currently selected question, despite the undesirable length of the generated answer, or to not accept, wherein responsive to a selection 660 to not accept, process 600 returns to repeat question and answer generating procedure 617, whereas responsive to a selection 660 to accept, process 600 continues to another selection at 670 to generate more questions or not.

As mentioned herein above, a template of sub-questions 540 (also referred to as “nested” questions) may be provided for a question 540, which VAM 520 may use as a basis to generate an answer. In one example, instead of providing question 540, “How can Blockchain technology help a Banking organization?” for VAM 520 to generate a 160 ENW answer worth 10 points on the exam, a nested question template having a structure as follows may be provided:

| Question to VAM | Hint to student &evaluator | ENW | Marks |
|---|---|---|---|
| What is Blockchain | Define Blockchain. | 30 | 2 |
| technology? | | | |
| Provide top 3 problems in | 3 relevant Banking | 30 | 3 |
| Banking to be solved thru | problems | | |
| blockchain. | | | |
| Suggest solutions of top 3 | Respective solution thru | 50 | 3 |
| banking problems thru | blockchain | | |
| blockchain. | | | |
| Discuss two case-studies | two case-studies | 50 | 2 |
| where solution has been | | | |
| implemented | | | |

The required values of above template for this question 540 (i.e., content of rows two through five) are provided via EDSM 530. Values of Column 1 (Question to VAM) & Column 3 (ENW) are used by VAM 520 to generate the optimized answer, whereas values of Column 2 (Hint to student & evaluator) and optional column-4 (marks) may be used by EDSM 530 to show students on-demand hints related to answer structure for the given question 540. (An answer generated in response to the template may be no different than a combination of answers to respective sub-questions 540, but without duplicate sentences. A question 540 may include sub-questions 540.)

In an embodiment of the present invention, once all questions 540 system 500 has generated for an exam are at least initially satisfactory, user 505 indicates to system 500 in selection 670 that no more questions are currently needed. In response, EDSM 530 automatically evaluates 680 (and present the evaluation, including scores described herein below) for all the questions 540 that have been selected for the exam, which includes determining scores for coverage and duplication of answers that VAM 520 generated 640 for those questions 540 and determining an overall exam quality score. More specifically, the exam quality score, is based on a weighted combination of the duplicity and coverage scores, the combined total of the understandability ratings of questions 540, the (overall number of words of the simulated answers generated by VAM 520/time allocated for the exam) and a measure of effectiveness of hints for questions 540 in the exam. The formula for the exam quality score gives great weight to low duplicity and high coverage, medium weight to understandability rating and number of words per minute, and low weighting to hint effectiveness.

Table headings for determining duplicity, according to an embodiment of the present invention:

| | | | | |
|---|---|---|---|---|
| Question | Answer | Paragraph/sub-answer | Sentence | count |
| number | number | number | text | |

For determining a duplicity score, the EDMS populates a table based on questions 540 generated by VAM 520. The table initially includes data for the first four fields shown in the headings above, wherein each record of the “sentence text” data is a respective one of questions 540. EDSM 530 sorts the table based on the text of the sentences, i.e., column 4 of the table, so that questions 540 are in a sequence wherein questions 540 that are the same are next to one another in the sequence. EDSM 530 then compares each question 540 to the next question 540 in the sequence and increments a counter in column 5 if they are the same. Once EDSM 530 has compared each question 540 to the next and counted the matches in this fashion, the final counter value represents a hard duplicity score (HDS).

Next, EDSM 530 performs a fuzzy text comparison of the first question 540 to each respective one of the other questions 540—i.e., the second question 540, third question 540, etc.—and increments a second counter for each fuzzy comparison that indicates a fuzzy match exceeding a predetermined threshold value. After fuzzy comparison of the first question 540 to each of the other questions 540 in this fashion, EDSM 530 removes the first question 540 from consideration and performs a fuzzy text comparison of the second question 540 to each respective one of the other questions 540—i.e., the third question 540, fourth question 540, etc. EDSM 530 increments the counter for each fuzzy match found for the second question 540, removes it from consideration, and proceeds to compare the third question 540 to the remaining questions 540, and so on until each question 540 has been compared to each remaining question 540. Once EDSM 530 has performed a fuzzy comparison of each question 540 to the rest and counted the matches in this fashion, the final value of the second counter represents a soft duplicity score (SDS).

Having computed an HDS and an SDS, EDSM 530 combines the scores to provide an overall duplicity score. In one embodiment, EDSM 530 combines the scores such that duplicity score=(2×HDS)+SDS, for example.

Regarding the coverage score, each exam covers a predefined portion of a course, such as a module or a chapter, for example, as indicated in the “scope” predefined parameter prior to beginning the exam preparation, according to an embodiment of the present invention. A coverage score provides a measure of the extent to which the exam presents questions 540 that concern all the topics and subtopics of the predefined portion of the course. To facilitate calculating the coverage score, EDSM 530 processes answers generated by VAM 520 to annotate each answer with topic/subtopic tags corresponding to the scope that was defined for the respective answer. (Alternatively, VAM 520 may annotate the answers in this fashion.) In one way of determining a coverage score, EDSM 530 counts all the topics and subtopics defined in the scope for the exam to cover and searches among those topics and subtopics for each topic and subtopic tag. EDSM 530 records and counts each topic or subtopic found and then, once searching is completed for all tags, computes a coverage score %=[(number of tagged topics and subtopics found in the search)/(total number of topics and subtopics the exam is defined to cover)]×100.

In response to presentation of the exam evaluation result at 680, user 505 may at 690 accept all questions 540 or else select to return to question and answer generating procedure 617 to change input 620 for one or more of the questions, repeat question 540 generation 625 for the changed input, etc.

It should be appreciated from the foregoing that embodiments of the present invention disclosed herein, which may be in the form of a system, method or computer program product, automatically provide to an exam preparer (e.g., an instructor applying the system, method or computer program product) potential, i.e., candidate, exam questions for course modules and corresponding, simulated answers for each of the questions that the user select, where questions and answers are based on the course content and user-defined scope, marks and length (words/minute). Consequently, questions tend to be more understandable and within the scope of content, so that students and evaluators find questions to be fair. Likewise, questions and answers tend to be within a predetermined, reasonable length. Accordingly, it should be appreciated that ways to generate exams described herein include computer system decision making based on defined rules and multi-dimensional data, which takes more factors into account than is possible with merely mental steps of human decision making and also reduces subjectivity that is inherently involved in human decision making.

In one aspect, more clarity and structure can be defined for lengthy questions through a nested questions template provided to the system, which not only helps student understand the point of view of the instructor, but also helps the students stay focused on relevant matters and helps evaluators do better score calculation.

Further, once the instructor has selected an initial set of exam questions, embodiments of the present invention provide help to the instructor in understanding whether the goals are met, so that the instructor can modify questions if needed to eliminate, or at least reduce, overlapping content in desired answers and to provide more complete coverage of the course content. In an example instance, user selects “How can Blockchain technology help a banking organization?” from among questions automatically generated according to the defined scope in the above blockchain example, topic b), whereupon the VAM automatically simulates an answer that the EDSM automatically evaluates and responsively presents, which includes information showing that the question requires an answer using only b) ii), iv) & v). Accordingly, the user may decide based on this information that question and simulated answer are sufficiently good, in which case, user may communicate a corrected scope to the students, i.e., b) ii), iv) & v).

The following provides a detailed description of aspects concerning a cloud computing embodiment of the present invention. It is to be understood that although this disclosure includes this detailed description regarding cloud computing, implementation of the teachings recited throughout this application are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portility (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

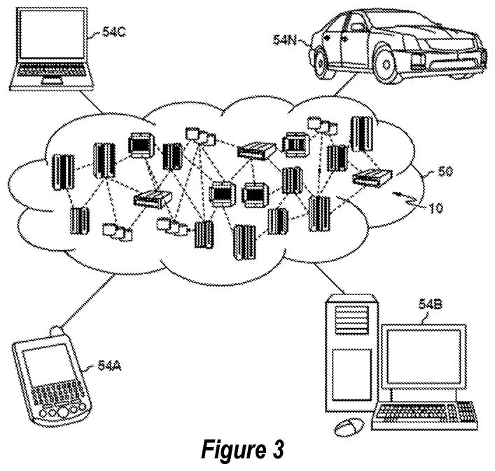

Referring now to FIG. 3, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 3 are intended to be illustrative only and that computing nodes 10 and cloud computing environment 50 can communicate with any type of computerized device over any type of network and/or network addressable connection (e.g., using a web browser).

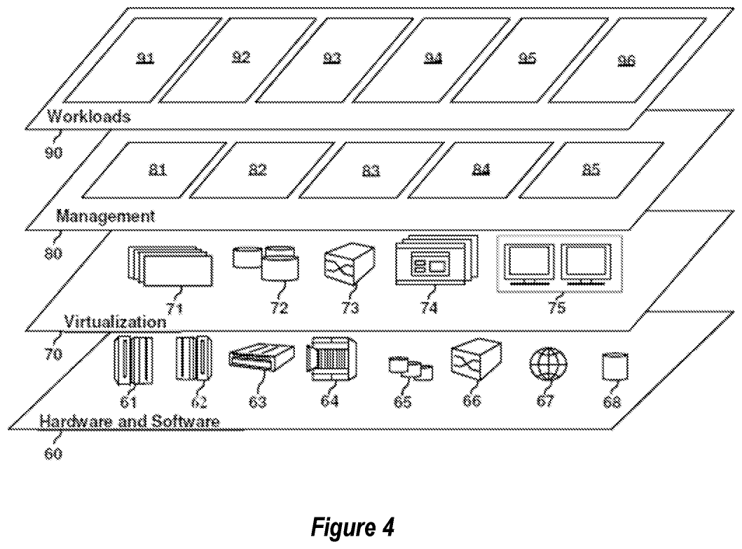

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and exam question generating and evaluating 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as C++, or the like, and procedural programming languages, such as the “C” programming language or similar programming languages. Reference herein to a “procedure” is not necessarily intended to indicate implementation of invention embodiments in a procedural language.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

One or more databases may be included in a host for storing and providing access to data for the various implementations. One skilled in the art will also appreciate that, for security reasons, any databases, systems, or components of the present invention may include any combination of databases or components at a single location or at multiple locations, wherein each database or system includes any of various suitable security features, such as firewalls, access codes, encryption, de-encryption and the like.

The database may be any type of database, such as relational, hierarchical, object-oriented, and/or the like. A database product that may be used to implement the databases is IBM® DB2®, or other available database products. (IBM and DB2 are trademarks of International Business Machines Corporation, registered in many jurisdictions worldwide.) The database may be organized in any suitable manner, including as data tables or lookup tables.

Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a key field in each of the manufacturer and retailer data tables. A key field partitions the database according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is preferably the same. However, data tables having similar, though not identical, data in the key fields may also be merged by using AGREP, for example.

While this specification contains many specifics, these should not be construed as limitations on the scope of the invention or of what can be claimed, but rather as descriptions of features specific to particular implementations of the invention. Certain features that are described in this specification in the context of separate implementations can also be implemented in combination in a single implementation. Conversely, various features that are described in the context of a single implementation can also be implemented in multiple implementations separately or in any suitable sub combination. Also, although features can be described above as acting in certain combinations and even initially claimed as such, features from a claimed combination can in some cases be excised from the combination, and the claimed combination directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Likewise, the actions recited in the claims can be performed in a different order and still achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, no element described herein is required for the practice of the invention unless expressly described as essential or critical.

The corresponding structures, materials, acts, and equivalents of all means or step plus function elements in the claims below are intended to include any structure, material, or act for performing the function in combination with other claimed elements as claimed.

It should be appreciated that the particular implementations shown and described herein are illustrative of the invention and its best mode and are not intended to otherwise limit the scope of the present invention in any way. Other variations are within the scope of the following claims. Many modifications and variations will be apparent to those of ordinary skill in the art without departing from the scope and spirit of the invention. The embodiments presented herein were chosen and described in order to best explain the principles of the invention and the practical application and to enable others of ordinary skill in the art to understand the invention for various embodiments with various modifications as are suited to the particular use contemplated. The description of the present invention has been presented for purposes of illustration and description but is not intended to be exhaustive or limited to the invention in the form disclosed.

What is claimed is:

1. A computer system implemented method comprising:
receiving, by the computer system, course content for a course of study;
performing a certain exam question generating procedure for the course content, including:
receiving, by the computer system, defining parameters for generating a potential exam question about the course content;
generating, by a first program module executing on the computer system, candidate questions for the potential exam question responsive to the course content and the received defining parameters;
presenting the candidate questions to a user by the computer system;
receiving, by the computer system, a selection of one of the candidate questions;
generating, by a second program module executing on the computer system, an answer for the selected question responsive to the course content, the received defining parameters and the selected question;
generating, by the first program module, an evaluation for the generated answer responsive to the generated answer, the course content, the received defining parameters and the selected question;
presenting the answer evaluation to the user by the computer system.

2. The method of claim 1, wherein the defining parameters define course content scope for the potential question, a desired understandability level for the potential question, a maximum possible credit grantable for a student answer to the potential question on the exam, a specified duration of the exam and an expected student answer-writing speed.

3. The method of claim 2, wherein generating the candidate questions for the potential exam question responsive to the course content and the received parameters includes:
determining, for a desirable answer to the potential exam question, a number of words based on the expected student answer-writing speed, the specified duration of the exam and the maximum possible credit grantable for a student answer to the potential question;
and
wherein generating the answer evaluation responsive to the generated answer, the course content, the received parameters and the selected question includes:
counting the number of actual words in the generated answer; and
comparing the number of actual words to the desirable number of words for the desirable answer.

4. The method of claim 2, wherein the course content includes headings and the definition of course content scope that is received as input includes identification of selected ones of the headings;
and
wherein generating the answer evaluation responsive to the generated answer, the course content, the received parameters and the selected question includes:
determining headings of the course content covered by the generated answer and comparing those to the identified headings of the course content received as input.

5. The method of claim 1, further comprising:
receiving, by the computer system, a second selection that is selected from a group comprising:
adjusting the selected question and repeating the generating of the answer evaluation;
rejecting the selected question and repeating the certain exam question generating procedure for a next potential exam question;
approving the selected question and repeating the certain exam question generating procedure for a next potential exam question; and
approving the selected question and ending the certain exam question generating procedure.

6. The method of claim 5, further comprising:
determining, by the computer system, a duplicity score of the approved exam questions responsive to ending the exam question generating.

7. The method of claim 5, further comprising:
determining, by the computer system, a coverage score of the approved exam questions responsive to ending the exam question generating.

8. A system for question generation comprising:
a processor; and
a computer readable storage medium connected to the processor, wherein the computer readable storage medium has stored thereon a program for controlling the processor, and wherein the processor is operative with the program to execute the program for:
receiving, by the computer system, course content for a course of study;
performing a certain exam question generating procedure for the course content, including:
receiving, by the computer system, defining parameters for generating a potential exam question about the course content;
generating, by a first program module executing on the computer system, candidate questions for the potential exam question responsive to the course content and the received parameters;
presenting the candidate questions to a user by the computer system;
receiving, by the computer system, a selection of one of the candidate questions;
generating, by a second program module executing on the computer system, an answer for the selected question responsive to the course content, the received parameters and the selected question;
generating, by the first program module, an evaluation for the generated answer responsive to the generated answer, the course content, the received parameters and the selected question;
presenting the answer evaluation to the user by the computer system.

9. The system of claim 8, wherein the parameters define course content scope for the potential question, a desired understandability level for the potential question, a maximum possible credit grantable for a student answer to the potential question on the exam, a specified duration of the exam and an expected student answer-writing speed.

10. The system of claim 9, wherein generating the candidate questions for the potential exam question responsive to the course content and the received parameters includes:
determining, for a desirable answer to the potential exam question, a number of words based on the expected student answer-writing speed, the specified duration of the exam and the maximum possible credit grantable for a student answer to the potential question; and
wherein generating the answer evaluation responsive to the generated answer, the course content, the received parameters and the selected question includes:
counting the number of actual words in the generated answer; and
comparing the number of actual words to the desirable number of words for the desirable answer.

11. The system of claim 9, wherein the course content includes headings and the definition of course content scope that is received as input includes identification of selected ones of the headings;
and
wherein generating the answer evaluation responsive to the generated answer, the course content, the received parameters and the selected question includes:
determining headings of the course content covered by the generated answer and comparing those to the identified headings of the course content received as input.

12. The system of claim 8, wherein the processor is operative with the program to execute the program for:
receiving, by the computer system, a second selection that is selected from a group comprising:
adjusting the selected question and repeating the generating of the answer evaluation;
rejecting the selected question and repeating the certain exam question generating procedure for a next potential exam question;
approving the selected question and repeating the certain exam question generating procedure for a next potential exam question; and
approving the selected question and ending the certain exam question generating procedure.

13. The system of claim 12, wherein the processor is operative with the program to execute the program for:
determining, by the computer system, a duplicity score and a coverage score of the approved exam questions responsive to ending the exam question generating.

14. A computer program product, including a computer readable storage medium having instructions stored thereon for execution by a computer system, wherein the instructions, when executed by the computer system, cause the computer system to implement a method comprising:
receiving, by the computer system, course content for a course of study;
performing a certain exam question generating procedure for the course content, including:
receiving, by the computer system, defining parameters for generating a potential exam question about the course content;
generating, by a first program module executing on the computer system, candidate questions for the potential exam question responsive to the course content and the received parameters;
presenting the candidate questions to a user by the computer system;
receiving, by the computer system, a selection of one of the candidate questions;
generating, by a second program module executing on the computer system, an answer for the selected question responsive to the course content, the received parameters and the selected question;
generating, by the first program module, an evaluation for the generated answer responsive to the generated answer, the course content, the received parameters and the selected question;
presenting the answer evaluation to the user by the computer system.

15. The computer program product of claim 14, wherein the parameters define course content scope for the potential question, a desired understandability level for the potential question, a maximum possible credit grantable for a student answer to the potential question on the exam, a specified duration of the exam and an expected student answer-writing speed.

16. The computer program product of claim 14, wherein generating the candidate questions for the potential exam question responsive to the course content and the received parameters includes:
determining, for a desirable answer to the potential exam question, a number of words based on the expected student answer-writing speed, the specified duration of the exam and the maximum possible credit grantable for a student answer to the potential question;
and
wherein generating the answer evaluation responsive to the generated answer, the course content, the received parameters and the selected question includes:
counting the number of actual words in the generated answer; and
comparing the number of actual words to the desirable number of words for the desirable answer.

17. The computer program product of claim 15, wherein the course content includes headings and the definition of course content scope that is received as input includes identification of selected ones of the headings; and
wherein generating the answer evaluation responsive to the generated answer, the course content, the received parameters and the selected question includes:
determining headings of the course content covered by the generated answer and comparing those to the identified headings of the course content received as input.

18. The computer program product of claim 14, wherein the instructions, when executed by the computer system, cause the computer system to implement a method comprising:
receiving, by the computer system, a second selection that is selected from a group comprising:
rejecting the selected question and repeating the certain exam question generating procedure for a next potential exam question;
approving the selected question and repeating the certain exam question generating procedure for a next potential exam question; and
approving the selected question and ending the certain exam question generating procedure.

19. The computer program product of claim 18, wherein the instructions, when executed by the computer system, cause the computer system to implement a method comprising:
determining, by the computer system, a duplicity score of the approved exam questions responsive to ending the exam question generating.

20. The computer program product of claim 18, wherein the instructions, when executed by the computer system, cause the computer system to implement a method comprising:
determining, by the computer system, a coverage score of the approved exam questions responsive to ending the exam question generating.
